(19) United States
(12) Patent Application Publication
(10) Pub. No.: US 2005/0058161 A1
(43) Pub. Date: Mar. 17, 2005

(54) Packet transport over General Packet Radio Service (GPRS) networks

(76) Inventors: Gennady Sorokopud, Netanya (IL); Yoaz Daniel, Haifa (IL)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 10/664,403

(22) Filed: Sep. 17, 2003

(51) Int. Cl. H04L 12/56

(52) U.S. Cl. 370/912; 370/401

(57) ABSTRACT

General Packet Radio Service (GPRS) networks that handle packetized transmissions employ an architecture that sits intermediate of the GPRS Gateway Support Node (GGSN) and the Wireless Application Protocol (WAP) gateway of the external network. This architecture improves the efficiency of WAP transmissions over the GPRS network (core and radio). This architecture is able to implement numerous advanced features of WAP protocols in accordance with WAP standard and requirements of the GPRS network, in order support both the client and server ends of the network.

### TECHNICAL FIELD

The present invention is directed to Wireless Application Protocol (WAP), including Wireless Transaction Protocol (WTP) and Wireless Session Protocol (WSP). In particular, the present invention is directed to adjusting WAP transmissions of packets to instant network characteristics and capabilities, and optimizing WAP transactions according to the intended WAP client, for example, in General Packet Radio Service (GPRS) Networks.

### BACKGROUND

Wireless Application Protocol (WAP) is a specification for a set of communication protocols to standardize a way that wireless devices, such as cellular telephones and radio transceivers, can be used for Internet access, including electronic mail, the World Wide Web and other Internet functions. WAP is becoming widely used as it is positioned at the convergence of two rapidly evolving network technologies, wireless data and the Internet.

FIG. 1 shows a contemporary WAP architecture. Here, a WAP terminal 20 initiates WAP transactions destined to a WAP gateway 22, typically a server or the like. The WAP transaction is received by a base station 24 linked to a General Packet Radio Service (GPRS) core network 26 including a GPRS Gateway Support Node (GGSN) 28, i.e., a router. The GGSN is linked to an external network 30 through a Gi interface 32.

The external network 30 includes the WAP gateway 22 and a content server 36, optionally linked to the WAP gateway 22 through a network, such as the Internet 40. An Multimedia Message Service (MMS) gateway 42 can be optionally linked directly the WAP gateway 22 or anywhere at the external network 30.

Transmissions between the WAP terminal 20 (or WAP client) and the WAP gateway 22 are packetized and in accordance with WAP standard protocol. This WAP protocol is a multilayer protocol.

FIG. 2 shows the layers of this multilayer protocol in their order of encapsulation. These layers include, from outermost to the innermost, GPRS bearer service 52, an Internet Protocol (IP) layer 53, a Wireless Datagram Protocol (WDP) 54 typically implemented through User Datagram Protocol (UDP), optional Wireless Transport Layer Security (WTLS) 55, Wireless Transaction Protocol (WTP) 56, Wireless Session Protocol (WSP) 57, and Wireless Application Environment (WAE) 58. One common implementation of this WAP standard protocol is through a component commonly known as a WAP stack with layers corresponding to those of FIG. 2.

This multilayer WAP protocol of FIG. 2, when used on a system on FIG. 1, 10 provides an efficient means of transmission over a GPRS network, between the WAP gateway 22 and the WAP client 20. Here a minimal amount of extra protocol information is added in order to transfer small amounts of packetized data across the GPRS network. However the abilities of the WAP protocol on the system of FIG. 1 are extremely limited.

This is because the WAP protocol is not aware of any characteristic of the GPRS network, and therefore can not implement an efficient flow control and retransmission policy of packetized transmissions. Additionally, advanced features of the WAP protocol require support on both the client and server ends of a network, and since they are optional, are normally not present in contemporary terminals and gateways, such as those of FIG. 1.

Yet another drawback of the contemporary system of terminals and gateways, such as those of FIG. 1, is that these systems can not adjust WAP transmissions in accordance with instantaneous changes in the characteristics of the GPRS network.

### SUMMARY

The present invention improves on the contemporary art by providing architectures and systems including architectures (collectively “architecture(s)”) that sit intermediate the GGSN and the Wireless Application Protocol (WAP) gateway of an external network, for example, in General Packet Radio Service (GPRS) networks. These architectures allow for creation of a mechanism for improving the efficiency of a WAP transmission, typically formed of packets, over GPRS network (core and radio). These architectures are able to implement numerous advanced features of WAP protocols in accordance with WAP standard and requirements of the GPRS network, in order support both the client and server ends of the network.

These architectures typically include a Quality of Service (QoS) server (or engine) with a traffic shaper and a packet classifier, a WAP proxy engine (WAP Proxy) and a GPRS monitoring engine. The QoS server, with its traffic shaper and packet classifier, along with the WAP proxy, are typically part of the external network, while the GPRS monitoring engine is typically linked to the GPRS core or radio network.

The architectures and systems disclosed herein are dynamic, as they can adjust WAP transmissions instantaneously and “on-the-fly”, in accordance with changes in GPRS network characteristics and capabilities.

An embodiment of the invention includes a method for facilitating Wireless Application Protocol (WAP) transmissions. This method includes: monitoring WAP traffic on a network; analyzing the WAP traffic for at least one WAP transaction; analyzing the at least one WAP transaction for the support of WAP Segmentation And Reassembly (SAR); and, transmitting content of the at least one WAP transaction to an intended WAP client. Here, for example, the analyzing of the WAP traffic includes analyzing the at least one packet of the at least one WAP transaction and the at least one packet includes the first packet of the at least one WAP transaction.

Another embodiment is directed to a packet processing apparatus. This apparatus includes a network interface configured for monitoring Wireless Application Protocol (WAP) traffic on a network; and a processor. The processor, for example, a microprocessor, is programmed to: analyze the WAP traffic for at least one WAP transaction; analyze the at least one WAP transaction for the support of WAP Segmentation And Reassembly (SAR); and cause transmission of the content of the at least one WAP transaction to an intended WAP client. The processor programmed to analyze the WAP traffic is additionally programmed to analyze at least one packet of the at least one WAP transaction. This at least one packet typically includes at least the first packet of the at least one WAP transaction.

Another embodiment is directed to a programmable storage device readable by a machine, tangibly embodying a program of instructions executable by a machine to perform method steps for facilitating Wireless Application Protocol (WAP) transmissions. These method steps are selectively executed during the time when the program of instructions is executed on said machine. These steps include: analyzing WAP traffic for at least one WAP transaction; analyzing the at least one WAP transaction for the support of WAP Segmentation And Reassembly (SAR); and causing transmission of the content of the at least one WAP transaction to an intended WAP client. Additionally, the analyzing of the WAP traffic includes analyzing at least one packet of the at least one WAP transaction, and for example, the at least one packet of the at least one WAP transaction includes the first packet of the at least one WAP transaction.

Another embodiment is directed to a method (process) for facilitating packet transport over a General Packet Radio Service (GPRS) network. The method includes: monitoring Wireless Application Protocol (WAP) traffic on the GPRS network for information about at least one WAP client; analyzing the WAP traffic for at least one characteristic of at least one WAP transaction destined for the at least one WAP client; and producing the optimized transmission for the at least one WAP client of the content of the at least one WAP transaction based on the at least one characteristic and the information about the at least one WAP client. Typically, the monitoring of the WAP traffic is performed on the Gb interface of the GPRS network.

Another embodiment is directed to a Wireless Application Protocol (WAP) proxy engine. This engine includes a first module for receiving General Packet Radio Service (GPRS) monitoring data, and at least one second module configured for receiving and analyzing WAP transactions according to the received GPRS monitoring data. The at least one second module is additionally configured for producing an optimized transmission for at least one WAP client of the content of at least one of the WAP transactions, based on at least one characteristic and information about the at least one WAP client. Typically, producing the optimized transmission includes queuing and shaping packets of the at least one of the WAP transactions.

Another embodiment is directed to a packet processing device. This device includes: a network interface configured for receiving General Packet Radio Service (GPRS) monitoring information and Wireless Application Protocol (WAP) traffic; and a processor. The processor is programmed to analyze the WAP traffic for at least one characteristic of at least one WAP transaction destined for at least one WAP client; and produce an optimized transmission for the at least one WAP client of the content of the at least one WAP transaction based on the at least one characteristic of the at least one WAP transaction destined for the at least one WAP client.

Also disclosed is a system for processing packets. This system includes a Quality of Service (QoS) server; a monitor for coupling to a network and detecting Wireless Application Protocol (WAP) traffic; and an engine coupled to the QoS server and the monitor. The engine is configured for: analyzing the WAP traffic for at least one characteristic of at least one WAP transaction destined for at least one WAP client; and, producing an optimized transmission for the at least one WAP client, based on the at least one characteristic of the at least one WAP transaction destined for the at least one WAP client, and the information about the at least one WAP client. The QoS server typically includes a traffic shaper and a packet classifier. The at least one characteristic of the at least one WAP transaction includes at least one of: Segmentation and Reassembly (SAR), Retransmission flag, WAP capabilities of the WAP client and the WAP gateway. The monitor is typically configured for continuously monitoring WAP traffic on the network. The engine is additionally configured to analyze the WAP traffic and produce the optimized transmission continuously, in response to the continuous monitoring of the WAP traffic on the network by the monitor. The engine is also configured to produce the optimized transmission, and is additionally configured for queuing and shaping packets of the at least one WAP transaction.

### BRIEF DESCRIPTION OF THE DRAWINGS

Attention is now directed to the drawing figures, where like numerals and/or characters indicate corresponding or like components. In the Drawings:

FIG. 1 is a diagram of a contemporary system for WAP;

FIG. 2 is a diagram of a protocol stack for WAP;

FIG. 3 is a diagram of an embodiment of a system in accordance with the present invention;

FIG. 4 is a flow diagram of an embodiment of a process in accordance with the present invention;

FIG. 5 is a diagram of another embodiment of a system in accordance with the present invention; and

FIG. 6 is a flow diagram of another embodiment of a process in accordance with the present invention.

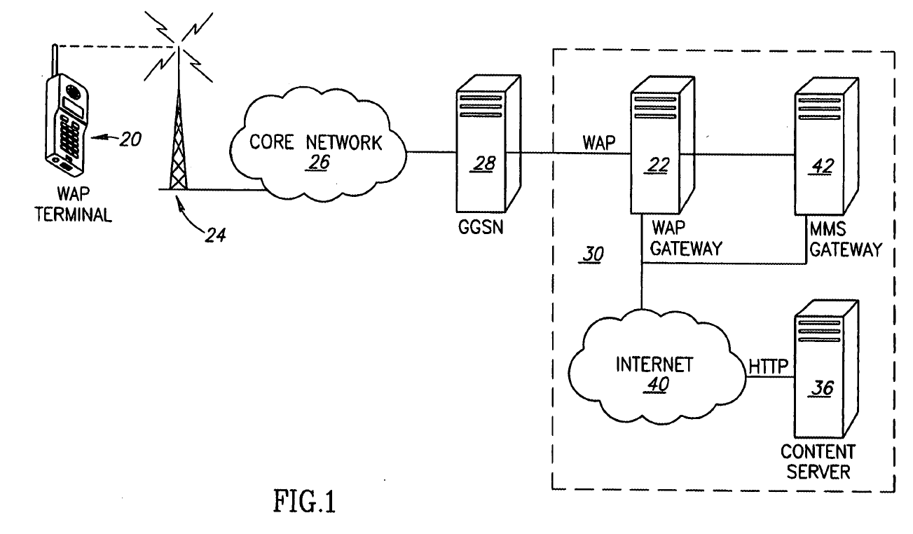

### DETAILED DESCRIPTION OF THE DRAWINGS

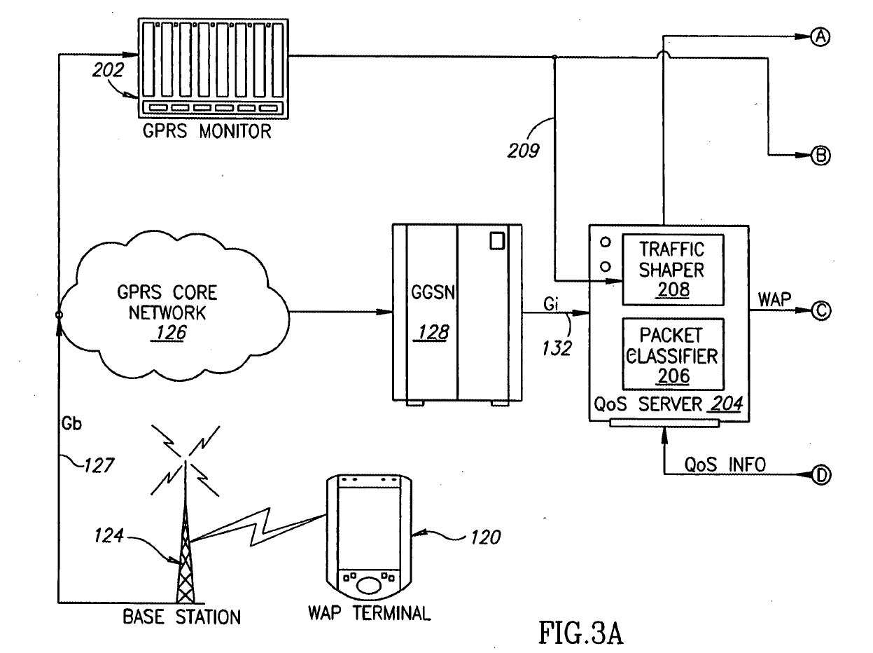

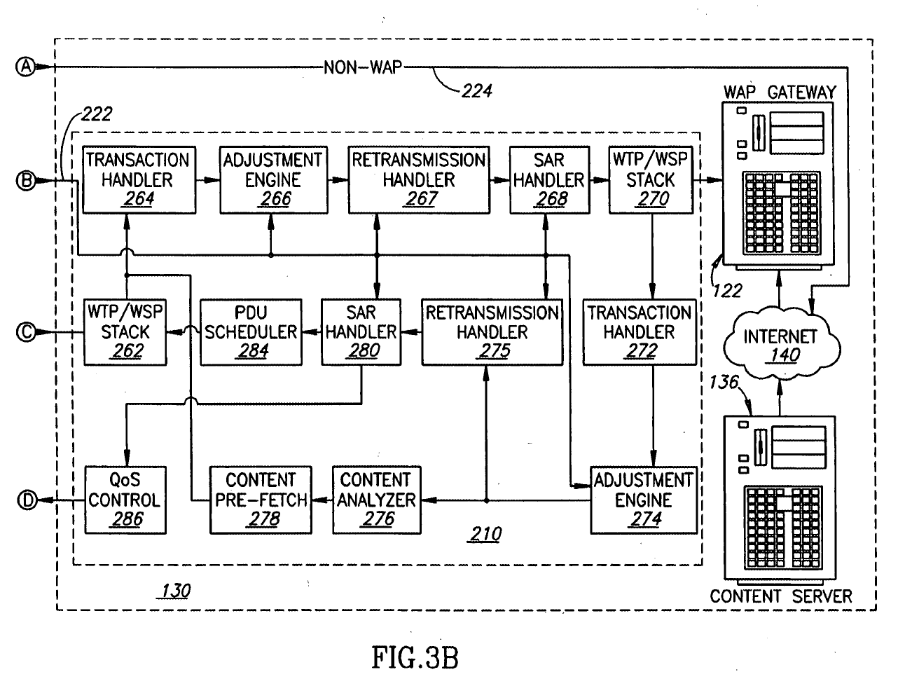

FIG. 3 details an exemplary architecture for a system 100 in accordance with an embodiment of the present invention. This architecture represents a virtual data flow of Wireless Application Protocol (WAP) packets, in both the uplink and the downlink directions, between different modules of the system 100.

A WAP terminal (or WAP client) 120 initiates WAP transactions destined to a WAP gateway 122, typically a server or the like. The WAP transaction is received by a base station 124 linked to a General Packet Radio Service (GPRS) core network 126 including a GPRS Gateway Support Node (GGSN) 128, i.e., a router. A GPRS monitor 202 sits along the GPRS core network 126, typically at a Gb interface 127. The GGSN 128 is linked to an external or host network 130 through a Gi interface 132.

The external network 130 includes the WAP gateway 122 and a content server 136, optionally linked to the WAP gateway 122 through a network, such as the Internet 140. This external network also includes a Quality of Service (QoS) server 204, typically including a packet classifier 206 and traffic shaper 208. These components (packet classifier 206 and traffic shaper 208) of the QoS server 204, as well as the QoS server itself, typically includes components such as storage media, processors (including microprocessors), network interfaces, and other hardware and software components.

This QoS server 204 is typically linked to the Gi interface 132 of the GGSN 128 and to the GPRS monitor 202 over a link 209, to receive data, typically corresponding to network traffic in GPRS radio and core networks (e.g., packet loss and timing information such as network latency, delays and capacity) from the GPRS monitor 202. A WAP proxy engine 210 sits intermediate the WAP gateway 122 and the QoS server 204. A packet classifier 206 inside the QoS server 204 is responsible for the redirection of the WAP traffic to the WAP proxy engine 210. The WAP proxy engine 210 is coupled to the WAP gateway 122 in order to receive all WAP data packets coming from the WAP gateway 122.

QoS information is received by the QoS server 204 from the WAP proxy engine 210 over a link 220. Capacity information, calculated by the GPRS monitor 202, is received by the WAP proxy engine 210 over a link 222. A non-WAP link 224 extends from any point along the external network 130 to the QoS server 204. This non-WAP link 224 is controlled by the packet classifier 206 and functions to accommodate packetized transmissions and packets that are not WAP-based.

Throughout this document there are references to “links”. These links can be single or multiple, and wired or wireless, or combinations thereof.

The QoS server 204 is designed for applying various policies to the packetized transmissions or traffic passing through it. The policies applied to the packetized traffic can be pre-configured, pre-programmed, calculated, and supplied through external links or any other suitable methods. For example, the QoS server 204 can be any commercially available server or other computer-type device, that includes hardware, software or combinations thereof, that includes a packet classifier and a traffic shaper (as detailed above). For example, this QoS Server 204 can be a QoS Policy Manager (QPM) from Cisco Systems Inc. of California or Mobile Traffic Shaper (MTS) from Cellglide UK.

The WAP proxy engine 210 can be within the QoS Server 204 or external thereto. This WAP proxy engine 210 is typically embodied as a computer-type device, or a server, that can be separate from the QoS Server 204. It typically includes components or modules, described below. The physical structure for performing the processes of the components or modules, typically includes storage media, processors (including microprocessors) and other hardware and software components. This physical structure can also include a network interface that receives GPRS monitoring information and WAP traffic, as well as additional storage media, processors (including microprocessors) and other hardware and software components. These components (modules) are connected by various arrows to define the uplink (from the QoS server 204 to the WAP gateway 122) path or direction and the downlink (from the WAP gateway 122 to the QoS server 204) path or direction, for packet flow.

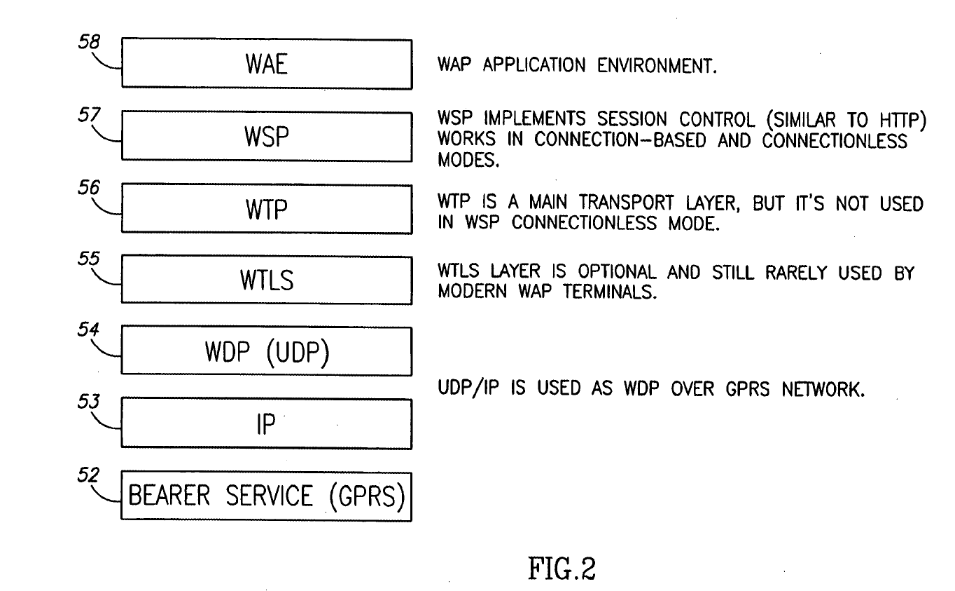

Data streams, typically at the uplink portion of packet WAP transaction(s) (of packets, for example, from a WAP client), in the uplink direction, enter the WAP proxy engine 210 through a WTP/WSP stack 262. In this stack 262 packets are decoded (specifically layers 56 and 57 of FIG. 2) in accordance with the WAP Standard 1.2.1, this WAP Standard 1.2.1, as described in: WAP-201-WTP-Wireless Application Protocol Wireless Transaction Protocol Specification, Approved Version, 19 Feb. 2000, ©Wireless Application Protocol Forum 2000; WAP-203-WSP-Wireless Application Protocol Wireless Transaction Protocol Specification, Approved Version, 4 May 2000, ©Wireless Application Protocol Forum 1999; and, WAP Architecture, Version 30 Apr. 1998, Wireless Application Protocol Architecture Specification, ©Wireless Application Protocol Forum, Ltd. 1998, all three of these documents incorporated by reference in their entirety herein.

The data stream enters a transaction handler 264 where WAP transactions are identified and data related to the identified transaction is extracted from the data stream, typically by analyzing at least the first sequential packet of a sequence of packets forming the data stream. The transaction handler 264 can also be such that it extracts a Transaction Identifier (TID) from WTP headers of packets of the identified transaction.

Transaction data (for each transaction) is passed, typically in sequence of TID, to an adjustment engine 266. In this engine, 266 WAP parameters can be adjusted in accordance with a capacity data obtained from the GPRS monitor 202 and in accordance with the WAP Standard 1.2.1. Additional data as to adjustment can be obtained from the data stream itself. The WAP parameters that can be adjusted include, for example, Maximum Receive Unit (MRU), Total Message Size, Delay Transmission Timer, Maximum Group, Client Service Data Unit (SDU) Size, Maximum Outstanding Requests (MOR) and Maximum Outstanding Push Requests (MOPR).

The transaction data is then analyzed by the retransmission handler module 267. This module 267 analyzes the packet or packets of the WAP transaction for the presence of retransmitted packet(s). If such packets are detected and they have been retransmitted at least once, a further analysis is made to determine if the aforementioned retransmission must be performed in order to ensure the correct transaction execution (if the retransmission is redundant or not). If the detected retransmitted packet is found not to be required for successful transaction execution, then it is removed (i.e. silently discarded).

This module 267 analyzes a packet based on the information supplied by the GPRS monitor 202, for example, information on packet loss and timing information, such as network latency or delays. Typically, a report of packet loss from the GPRS monitor 202, which is related to a particular packet or transaction, that is being analyzed for retransmissions, will be passed to the Segmentation and Reassembly (SAR) handler module 268. Similarly, in a case of network delay exceeding the assigned WAP timeout value (for example, approximately 5 seconds).

The adjusted or not adjusted transactions (in accordance with a sequence detailed above), once passed through the retransmission handler module 267 (provided that the packet were not removed in the retransmission handler module 267), enter the Segmentation and Reassembly (SAR) Handler 268, where SAR support of the WAP client is analyzed and recorded.

The transaction data is then passed to the WSP/WTP stack 270 where WAP packets are encoded and sent to the WAP gateway 122.

In the downlink direction, the downlink portion of the WAP transaction(s) of a data stream, enter the WAP proxy engine 210 through the WTP/WSP stack 270. In this stack 270, packets are decoded (specifically layers 56 and 57 of FIG. 2) in accordance with the WAP Standard 1.2.1. The data stream enters a transaction handler 272 (similar to transaction handler 264) where WAP transactions are identified and isolated, and data related to the identified transaction is extracted from the data stream. The transaction handler 272 can also be such that it extracts a Transaction Identifier (TID) from WTP headers of packet of the identified transaction, and waits (typically based on a pre-set time) until all transaction data is received, and the complete transaction is isolated.

Each isolated transaction is passed, typically in sequence of TID, to the adjustment module 274. In this module 274, WAP parameters can be adjusted in accordance with a capacity data obtained from the GPRS monitor 202 and that of the WAP Standard 1.2.1. Additional data as to adjustment can be obtained from the data stream itself. The WAP parameters that can be adjusted include, for example, Total Message Size, Delay Transmission Timer, Maximum Group, Server SDU Size, Maximum Outstanding Requests (MOR) and Maximum Outstanding Push Requests (MOPR).

The transaction data is then analyzed by the retransmission handler module 275. This module 275 analyzes the packet or packets of the WAP transaction for the presence of retransmitted packet(s). If such packets are detected and they have been retransmitted at least once, a further analysis is made to determine if the aforementioned retransmission must be performed in order to ensure the correct transaction execution. If the detected retransmitted packet is found not to be required for successful transaction execution, then it is removed (i.e., silently discarded).

This module 275 analyzes a packet based on the information supplied by the GPRS monitor 202, for example, information on packet loss and timing information, such as network latency or delays. Typically, a report of packet loss from the GPRS monitor 202, which is related a particular packet or transaction, that is being analyzed for retransmissions, will be passed to the SAR handler module 280. Similarly, this will occur in a case of network delay exceeding the assigned WAP timeout value (for example, approximately 5 seconds).

The content of the isolated transaction from the adjustment module 274 is transferred to the content analyzer module 276, where the content type is identified. In accordance with the identified content type the content (typically WML) is split into elements. This list of elements is then transferred to a content pre-fetch module 278.

The content pre-fetch module 278 analyzes the supplied list of elements, identifying externally referenced data. According to the internally defined rules to obtain various desired data, the externally referenced data is scheduled for pre-fetching. This pre-fetching includes generation a WAP transaction on behalf of the WAP client. Those generated transactions are passed to the transaction handler 264 and sent to the WAP gateway 122, in the uplink direction (as detailed above).

The adjusted or non-adjusted transactions (in accordance with a sequence detailed above), enter the Segmentation and Reassembly (SAR) Handler 280, where: 1) SAR support can be added into each transaction; and 2) SAR parameters, for example, Maximum Group (in accordance with the WAP Standard 1.2.1), are adjusted, based on presence of SAR support in the requisite transaction, in accordance with the capacity information received from the GPRS monitor 202.

Transaction data is transferred to the Packet Data Unit (PDU) Scheduler 284, where the data is organized into packets, placed in an order inside an outgoing queue, and transmitted in accordance with this order in pre-set time intervals to the WTP/WSP stack 262.

QoS control module 286 creates an appropriate QoS policy to be transmitted to the QoS server 204. The QoS policy is based on: 1) presence of SAR support inside the transaction; 2) presence of IP fragmentation in transaction packets; and 3) pre-configured rules. The resulting QoS policy is received by the QoS server 204 and applied on packet transmissions in the downlink direction related to the packets corresponding to the transaction data.

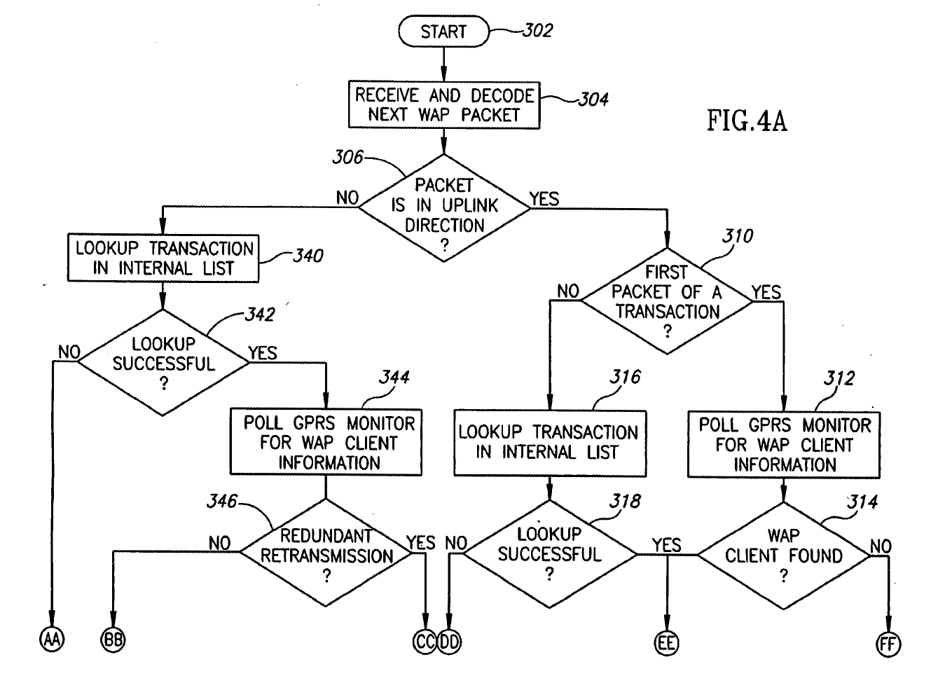

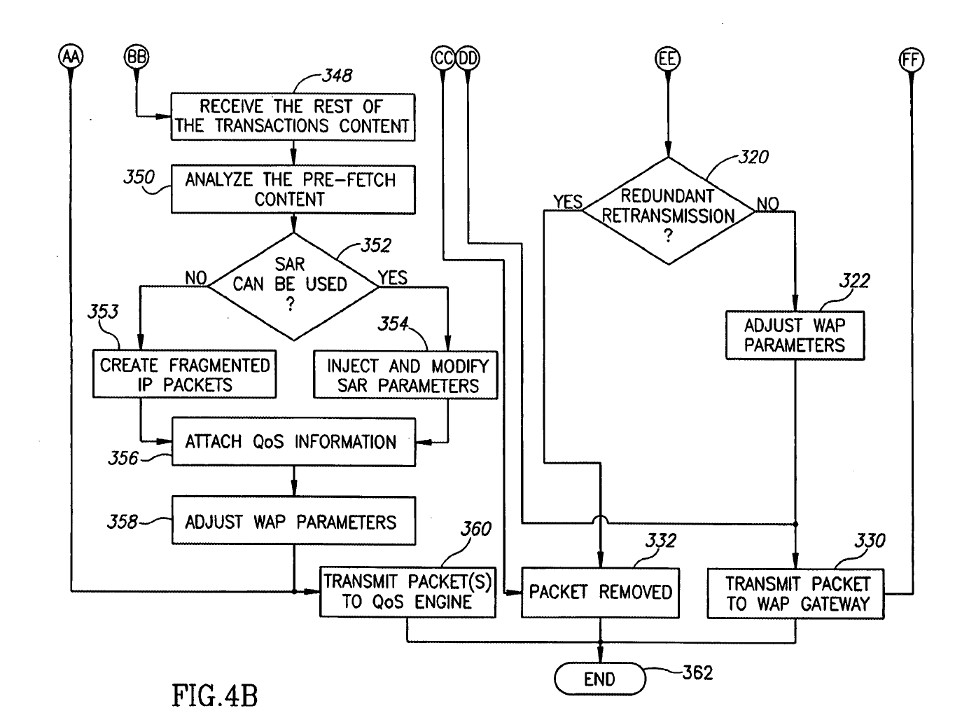

Turning also to FIG. 4, there is detailed a process in accordance with an embodiment of the present invention. This process is expressed by way of a flow diagram, an exemplary implementation of the architecture shown in FIG. 3, and described above.

Initially, the process begins at the Start in block 302. Next, a WAP packet is taken from the network, from either the WAP gateway 122 or the QoS server 204. The packet is then decoded into components in accordance with WAP Standard 1.2.1, in block 304. In block 306 the packet is analyzed if it is flowing in the uplink direction (as described above).

If the packet is analyzed to be flowing in the uplink direction, the process moves to block 310, where it is determined if the packet being examined is the first packet of a WAP transaction.

If the packet was found to be the first packet of a WAP transaction, the process moves to block 312, where GPRS monitor 202 is polled for information describing the WAP client 120 connected to the GPRS network. This information includes, for example, capabilities of a WAP client and GPRS link conditions. Next, the received information is analyzed to see if it contains a data related to the WAP client 120, at block 314. If no information about the WAP client 120 is returned, the process moves to block 330, where the packet is transmitted to the WAP gateway 122.

Returning to block 310, if the packet was determined not to be the first packet of the WAP transaction, the process moves to block 316, where the WAP transaction is looked up in the internal WAP transaction lookup table (typically stored in memory associated with the WAP proxy engine 210). Next, in block 318, the result of the lookup is analyzed. If the WAP transaction is not found in the internal WAP transaction lookup table, then the process moves to block 330, where the packet is transmitted to the WAP gateway 122.

Returning to block 314, should the WAP client have been found, and also returning to block 318, where, if the WAP transaction has been found, the process moves to block 320. Here, it is determined if the packet is a part of the redundant retransmission, for example, in accordance with the procedure detailed above for the retransmission handler module 267.

If the packet is found not to be a part of the redundant retransmission, the process moves to block 322, where WAP parameters are adjusted in accordance with the information received at block 312 from the GPRS monitor 202. The adjustment is performed, for example, in accordance with the procedure detailed above for the adjustment module 266. Once adjusted, the process moves to block 330, where the packet is transmitted to the WAP gateway 122.

Returning to block 320, should the packet to be found to be a part of the redundant retransmission, the process moves to block 332, where the packet is removed (i.e., silently discarded).

Returning to block 306, if the packet is found to be flow in the downlink direction, the process moves to block 340. In block 340, the process of block 316 is performed, and the process then moves to block 342, where the process of block 318 is performed.

If the packet lookup was not successful, as detailed above, the process moves to block 360. At this block 360, the packet is transmitted to the QoS server 204.

Returning to block 342, if the lookup was successful, the process moves to block 344, where the process of block 312 is performed. The process then moves to block 346.

Here (at block 346), it is determined if the packet is a part of the redundant retransmission, for example, in accordance with the procedure detailed above for retransmission handler module 275. If the packet is found to be a part of the redundant retransmission, the process moves to block 332, where the packet is removed (i.e., silently discarded).

If the packet is not found to be a part of the redundant retransmission, the process moves to block 348. Here the process is delayed until all packets of the WAP transaction are received from the WAP gateway 122.

The process then moves to block 350. Here the content of the isolated transaction is identified. In accordance with the identified content type the content (typically WML) is split into elements. This list of elements is then pre-fetched as the elements are analyzed for the externally referenced data. According to the internally defined rules to obtain various desired data, the externally referenced data is scheduled for pre-fetching. This pre-fetching includes generation a WAP transaction on behalf of the WAP client. These generated transactions are sent to the WAP gateway 122 in the uplink direction (as detailed above). Block 350 is typically performed in accordance with the procedure detailed above for modules 276 and 278 of FIG. 3.

The process now moves to block 352, where SAR analysis is performed. If the analysis results do not allow for SAR to be used for the WAP transaction, the process moves to block 353, where the content of the transaction is split into IP fragments. These fragments typically include whole packets and/or portions thereof.

If SAR can be used for the WAP transaction the process moves to block 354, where SAR parameters are injected and modified in accordance with the information received from the GPRS monitor 202.

The procedures performed in blocks 352 and 354 are, for example, performed in SAR handler module 280 of FIG. 3, in accordance with that described above.

Blocks 353 and 354 send their data to block 356, where an appropriate QoS policy is created, to be transmitted to the QoS server 204. For example, the QoS policy is based on: 1) presence of SAR support inside the transaction, as was determined in block 352; 2) presence of IP fragmentation in transaction packets, according to block 353; and 3) pre-configured rules. The resulting QoS policy (information) is attached to the WAP transaction and transmitted to the QoS server 204.

The process moves to block 358, where WAP parameters are adjusted in accordance with the information received at block 344 from the GPRS monitor 202. The adjustment is performed, for example, in accordance with the procedure detailed above for the adjustment module 274. Once adjusted, the process moves to block 360, where the transaction data is transmitted to the QoS server 204.

With the process now at either of blocks 330, 332 or 360, the process ends at block 362. The process is repeated for every subsequent WAP packet (as it again starts at block 302).

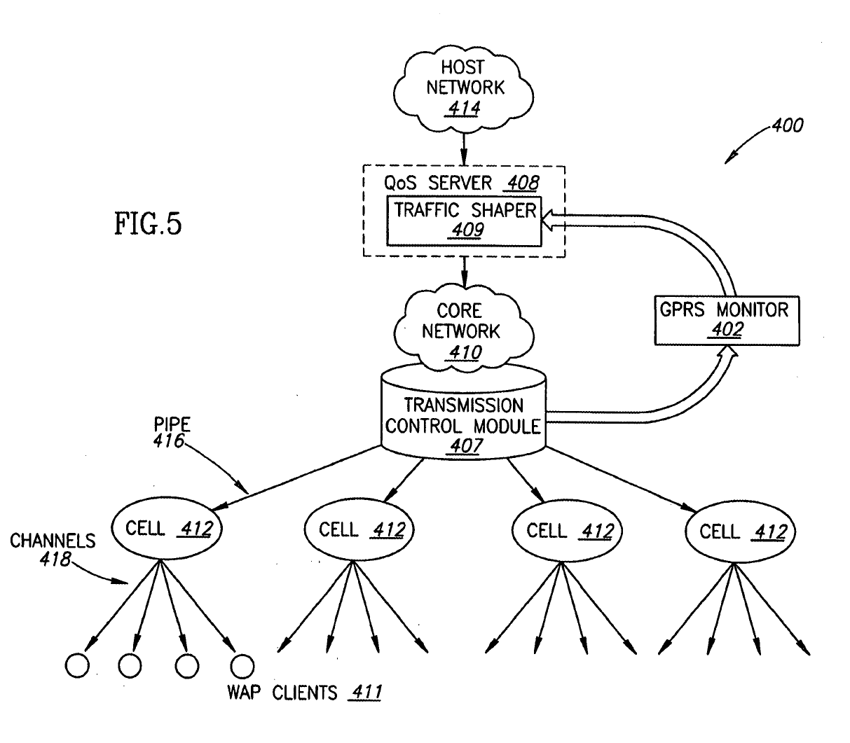

Turning now to FIG. 5, there shown an example system 400, including a GPRS monitor 402, manager, processor or the like, typically in software, hardware or combinations thereof. The GPRS monitor 402 monitors a transmission control module 407, for the total transmission rate from the core network 402 to the WAP client(s) 411. The information form the GPRS monitor 402 is transmitted to the QoS server 408, and in particular, the traffic shaper 409, typically within this QoS server 408. This monitoring can be for the transmission rate from the core network 410 to the WAP client(s) 411, or for flow control messages from the cell(s) 412 to the core network 410 or the transmission control module 407.

The core network 410 receives data packet traffic from the host network 414, and sends it, using its transmission control module 407, to cells 412 over links (as described above) or pipes 416. The cells 412 transmit the data traffic to WAP clients 411 over channels or links 418, typically radio channels or the like. The WAP clients 411, are similar to the WAP terminal or client(s) shown in FIG. 3 and described above, and can be manned or unmanned devices, such as Personal Digital Assistants (PDAs), mobile/cellular phones, etc., able to receive data over channels or links 418.

The GPRS monitor 402 is similar to the GPRS monitor 202 shown in FIG. 3 and described above. QoS server 408 and traffic shaper 409 are also similar to the QoS server 204 and traffic shaper 208 shown in FIG. 3 and described above. The host network 414 is similar to the external or host network 130 shown in FIG. 3 and described above.

The GPRS core network 410 can be a network, such as that detailed in, “3^{rd} Generation Partnership Project; Technical Specification Group Services and System Aspects; General Packet Radio Service (GPRS); Service description; Stage 2, 3GPP TS 23.060, V3.7.0 (2001-03) Technical Specification (Release 1999), ©3GPP TS Organizational Partners 2000” (hereinafter 3GPP TS 23.060), this document incorporated by reference herein. The cells 412 are typically GSM/GPRS shared access media.

The links or pipes 416 are typically E1 or Frame Relay lines, and the protocol is typically Base Station GPRS Protocol (BSSGP) in accordance with that described in, “3^{rd} Generation Partnership Project; Technical Specification Group GSM/EDGE Radio Access Network; General Packet Radio Service (GPRS); Base Station System (BSS)—Serving GPRS Support Node (SGSN); BSS GPRS Protocol (BSSGP), 3GPP TS 08.18 v6.8.0 (2001-06) Technical Specification (Release 1997), ©3GPP Organizational Partners 2001” (hereinafter 3GPP TS 08.18), this document incorporated by reference herein, in accordance with the Gb interface definition in, “Digital cellular telecommunications system (Phase 2+); General Packet Radio Service (GPRS); Base Station System (BSS)—Serving GPRS Support Node (SGSN) interface; Gb Interface Layer 1 (3GPP TS 08.14 version 8.0.1 Release 1999), ETSI TS 101 298 V8.0.1 (2002-05) Technical Specification, ©European Telecommunications Standards Institute 2002” (hereinafter 3GPP TS 08.14), this document incorporated by reference herein. The channels or links 418 are typically over air interfaces through radio channels.

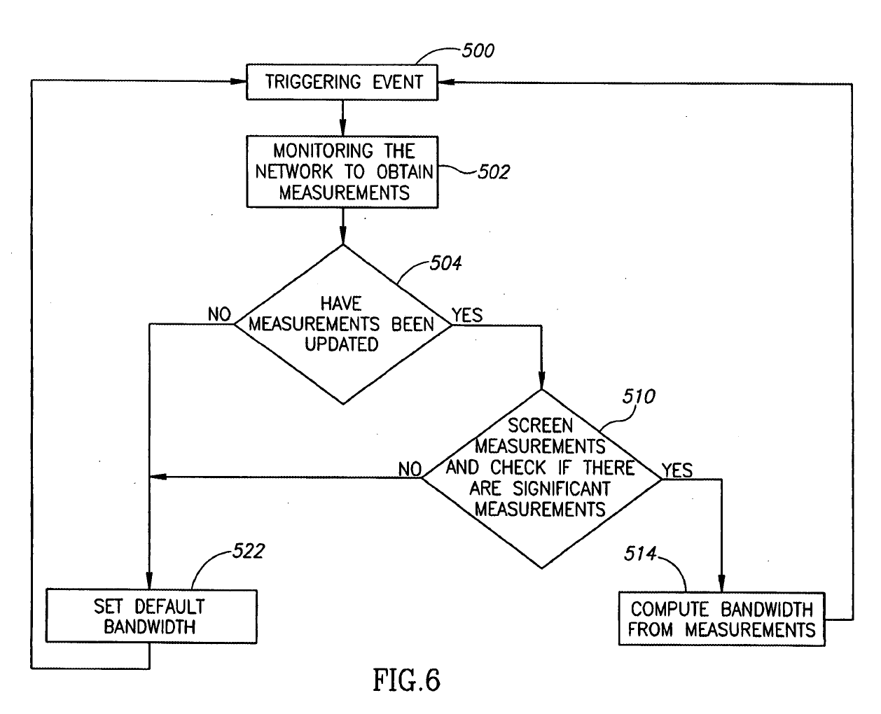

Turning also to FIG. 6, there is detailed a process in accordance with an embodiment of the present invention. This process is expressed by way of a flow diagram, an exemplary implementation of the system 400 shown in FIG. 5, and described above. While a single cycle of operation is shown, the process may also be applied multiple cycles.

The process is an iterative process, which is continuous over time. It is initiated by a triggering event, and involves continuously monitoring the transmission control module 407 (FIG. 5), typically for flow control messages received from cell 412 (FIG. 5), these typically include bucket size and leak-rate.

The process detailed below processes and analyzes the measurements obtained in stages. At a first stage, analysis shows whether flow control messages obtained are relevant, typically by verifying whether the messages are updated or updates are unavailable. If updates are unavailable, a default cell bandwidth is set as the process output. Alternately, a second level of analysis is preformed.

In this second stage of analysis insignificant measurement are screened out, while significant messages are maintained for further computation. If after this screening out no significant measurements are available, a default bandwidth is set. Alternately cell bandwidth is computed out of the significant measurements. As this bandwidth is set as the process output, a new triggering event is awaited.

The process begins at block 500, with a triggering event. This triggering event is typically generated by events, including, certain timing events, arrival of a message or signal or accumulation of a predefined number of measurements. The default triggering event is a timing event generated every 5 seconds.

At block 502, the network is monitored to obtain measurements, typically at the links or pipes 416. These measurements are typically obtained at predetermined time intervals, for example, every 10 seconds. These measurements are typically multiple values, but could also be a single value, as determined by a supplied configuration. Typical measurements (measured values) include, current bucket size, Bᵢ, and current leak-rate Lᵢ, both typically taken from the shared access media or cell 412, or the core network 410 (e.g., the Base Station System (BSS) according to the 3GPP TS 08.18), or the core network transmission control device 407 (FIG. 5).

According to the GPRS Standard 3GPP TS 08.18, these messages, both of leak rate and bucket size, are mandatory both for each cell 412 (FIG. 5) and WAP clients 411 (FIG. 5). Both types of measurements, for all WAP clients 411 and cells 412, are collected.

At block 504 the measurements are analyzed, to determine the extent to which they have been revised or updated. For example, this could be done by analyzing the arrival time of these measurements, or by analyzing the values of these measurements compared to previous measurements or defaults. By default, the analysis is performed by checking the arrival time of the measurements. If the measurements had arrived within a pre-defined time period, for example 30 seconds, they are considered updated. If the messages are not updated the process moves to block 522, where the default cell bandwidth is set.

The default cell bandwidth is set according to cell-specific data, system administrator's requirements, etc. The default setting for the cell bandwidth (C) is, for example, C=48000 Bits per second.

Returning to block 504, if the process utilizes the updates, these updates are suitable for screening performed at block 510, to where the process now moves.

At block 510 insignificant measurements are screened out. This can be done, for example, by filtering, such as median filtering, by considering the arrival times and sequence ordering of the messages, etc. The default process follows the elimination process described below.

If there is a flow control message related to one of the cells 412, including a leak-rate message within certain boundaries, then this message and all other flow control messages related to the cell and including leak rate messages within the same boundaries are considered significant, and all other messages related to the same cell are considered insignificant. The default boundaries are, for example, set at 0 kilobits per second (for the lower boundary), and 100 kilobits per second (for the upper boundary).

Alternately, all flow control messages relating to the WAP clients of the requisite cell are considered significant, and all other measurements are considered insignificant. If no flow control messages relating to users of the requisite cell exist, all measurements are considered insignificant.

If no significant measurements exist, after the screening, the process moves to block 522, where the default bandwidth is set, as detailed above. If significant measurements exist, the process moves to block 514.

At block 514, cell bandwidth is computed from the significant measurements screened at block 5 10. The computation in block 514 can utilize bucket size messages, leak-rate messages or combinations thereof, and can include averaging, such as geometrical or exponential averaging, filtering, such as median filtering, smoothing, or combinations thereof. The default computation is described now, and is dependent on the type of significant measurement retrieved in block 510. The default computation in block 514 is formed from two stages.

In the first stage, a gross estimation of cell bandwidth, G, is computed. This computation can rely on the leak rate messages related either to the requisite cell or on the leak rate messages related to all WAP clients of the requisite cell. If significant measures as retrieved from block 510 include leak-rate messages related to the requisite cell, then the computation relies on this measurement, according to the following exemplary formula:
G=L
where,
L is the last leak rate reported, related to the requisite cell.

Alternately, if the only significant measurements relate to the WAP clients of the requisite cell, the computation is done according to the following exemplary formula:
G=Σ Lu
where,
Lu is the last leak rate relating to user u of the requisite cell; and
summation (Σ) is done over all WAP clients of the requisite cell.

With the gross estimation of the cell bandwidth being computed, the second stage of the default exemplary computation of block 514 is performed. At this stage the cell bandwidth, C, is computed. This computation can be done by averaging, e.g. over time, filtering or combinations thereof. Alternatively, the default computation of this stage can be done by estimating the number of time slots allocated in the cell, in accordance with the following exemplary formula:
C=Ts·Uts

In the above formula, Uts is a default bandwidth capacity for a time slot. The default value for Uts is, for example, 12 kilobits per second. Ts is the estimated number of time slots allocated in the cell. The default value for Ts, for example, is the greatest integer less than or equal to the following quantity: G/Uts.

When the cell bandwidth, C, is computed, the operation of block 514 is concluded.

Returning to block 500, from either from block 514 or block 522, a cycle is complete. During this cycle, available cell bandwidth has been computed dynamically in an automatic manner and “on the fly”. Subsequent cycle(s) may be performed as necessary or desired (upon returning to block 500).

The above described processes including portions thereof can be performed by software, hardware and combinations thereof. These processes and portions thereof can be performed by computers, computer-type devices, workstations, processors, microprocessors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

1. A method for facilitating Wireless Application Protocol (WAP) transmissions comprising:
monitoring WAP traffic on a network;
analyzing the WAP traffic for at least one WAP transaction;
analyzing the at least one WAP transaction for the support of WAP Segmentation And Reassembly (SAR); and
transmitting content of the at least one WAP transaction to an intended WAP client.

2. The method of claim 1, wherein the analyzing of the WAP traffic includes analyzing the at least one packet of the at least one WAP transaction.

3. The method of claim 2, wherein the at least one packet includes the first packet of the at least one WAP transaction.

4. The method of claim 3, wherein the first packet of the at least one WAP transaction is from a WAP client.

5. The method of claim 2, wherein analyzing the at least one WAP transaction for the support of WAP SAR includes, analyzing at least one packet from a WAP gateway, if support of WAP SAR is detected.

6. The method of claim 5, additionally comprising, modifying the at least one WAP transaction by adjusting SAR parameters of the transaction to produce a transmission for the WAP client.

7. A packet processing apparatus comprising:
a network interface configured for monitoring Wireless Application Protocol (WAP) traffic on a network; and
a processor programmed to:
analyze the WAP traffic for at least one WAP transaction;
analyze the at least one WAP transaction for the support of WAP Segmentation And Reassembly (SAR); and
cause transmission of the content of the at least one WAP transaction to an intended WAP client.

8. The apparatus of claim 7, wherein the processor programmed to analyze the WAP traffic is additionally programmed to analyze at least one packet of the at least one WAP transaction.

9. The apparatus of claim 8, wherein the at least one packet includes at least the first packet of the at least one WAP transaction.

10. The apparatus of claim 9, wherein the first packet of the at least one WAP transaction is from a WAP client.

11. The apparatus of claim 7, wherein the processor programmed to analyze the at least one WAP transaction for the support of WAP Segmentation And Reassembly (SAR) is additionally programmed to: analyze at least one packet from a WAP gateway for the support of WAP SAR, if support of WAP SAR is detected.

12. The apparatus of claim 1, wherein the processor programmed to analyze the at least one WAP transaction for the support of WAP Segmentation And Reassembly (SAR) is additionally programmed to: modify the WAP transaction by adjusting SAR parameters of the transaction to produce a transmission for the WAP client, if support of WAP SAR is detected.

13. A programmable storage device readable by a machine, tangibly embodying a program of instructions executable by a machine to perform method steps for facilitating Wireless Application Protocol (WAP) transmissions, said method steps selectively executed during the time when said program of instructions is executed on said machine, comprising:
analyzing WAP traffic for at least one WAP transaction;
analyzing the at least one WAP transaction for the support of WAP Segmentation And Reassembly (SAR); and
causing transmission of the content of the at least one WAP transaction to an intended WAP client.

14. The programmable storage device of claim 13, wherein the analyzing of the WAP traffic includes analyzing at least one packet of the at least one WAP transaction.

15. The programmable storage device of claim 14, wherein the at least one packet of the at least one WAP transaction includes the first packet of the at least one WAP transaction.

16. The programmable storage device of claim 15, wherein the first packet of the at least one WAP transaction is from a WAP client.

17. The programmable storage device of claim 13, wherein analyzing the at least one WAP transaction for the support of WAP Segmentation And Reassembly (SAR), includes analyzing at least one packet from a WAP gateway, if support of WAP SAR is detected.

18. The programmable storage device of claim 13, wherein analyzing the at least one WAP transaction for the support of WAP Segmentation And Reassembly (SAR), includes, modifying the WAP transaction by adjusting SAR parameters of the transaction to produce a transmission for the WAP client, if support of WAP SAR is detected.

19. A method for facilitating packet transport over a General Packet Radio Service (GPRS) network comprising:
monitoring Wireless Application Protocol (WAP) traffic on the GPRS network for information about at least one WAP client;
analyzing the WAP traffic for at least one characteristic of at least one WAP transaction destined for the at least one WAP client; and
producing the optimized transmission for the at least one WAP client of the content of the at least one WAP transaction based on the at least one characteristic and the information about the at least one WAP client.

20. The method of claim 19, wherein the monitoring of the WAP traffic is performed on the Gb interface of the GPRS network.

21. The method of claim 19, wherein the at least one characteristic of the at least one WAP transaction includes at least one of: SAR, Retransmission flag, WAP capabilities of the WAP client and the WAP gateway.

22. The method of claim 21, wherein analyzing the WAP traffic includes matching the at least one WAP transaction to the information received from the monitoring of the GPRS network.

23. The method of claim 22, wherein the matching includes at least a partial correspondence of the WAP transaction and the information received from the monitoring of the GPRS network.

24. The method of claim 19, wherein the producing the optimized transmission includes adjusting the characteristics of the at least one WAP transaction according to the information received from the monitoring of the GPRS network.

25. The method of claim 20, wherein the monitoring of the WAP traffic is performed by a GPRS monitor.

26. The method of claim 10, wherein the monitoring WAP traffic on the GPRS network is continuous.

27. The method of claim 26, wherein the analyzing the WAP traffic and the producing the optimized transmission are performed continuously in response to the continuous monitoring.

28. The method of claim 19, wherein the producing the optimized transmission includes queuing and shaping packets of the at least one WAP transaction.

29. The method of claim 19, wherein the packet transport includes packets flowing in an uplink direction.

30. The method of claim 19, wherein the packet transport includes packets flowing in a downlink direction.

31. A Wireless Application Protocol (WAP) proxy engine comprising:
a first module for receiving General Packet Radio Service (GPRS) monitoring data; and
at least one second module configured for receiving and analyzing WAP transactions according to the received GPRS monitoring data.

32. The WAP Proxy engine of claim 31, wherein said at least one second module is additionally configured for producing an optimized transmission for at least one WAP client of the content of at least one of the WAP transactions, based on at least one characteristic and information about the at least one WAP client.

33. The WAP Proxy engine of claim 32, wherein the second module configured for analyzing WAP transactions is additionally configured to analyze the at least one WAP transaction by matching the at least one WAP transaction to the GPRS monitoring data.

34. The WAP Proxy engine of claim 33, wherein the matching includes at least a partial correspondence of the at least one WAP transaction and the GPRS monitoring data.

35. The WAP Proxy engine of claim 32, wherein the producing an optimized transmission includes, adjusting the characteristics of the at least one WAP transaction according to the information received from the GPRS monitoring data.

36. The WAP Proxy engine of claim 33, wherein the analyzing the WAP transactions and the producing of an optimized transmission are performed continuously in response to the GPRS monitoring data.

37. The WAP Proxy engine of claim 32, wherein the producing the optimized transmission includes queuing and shaping packets of the at least one of the WAP transactions.

38. A packet processing device comprising:
a network interface configured for receiving General Packet Radio Service (GPRS) monitoring information and Wireless Application Protocol (WAP) traffic; and
a processor programmed to:
analyze the WAP traffic for at least one characteristic of at least one WAP transaction destined for at least one WAP client; and
produce an optimized transmission for the at least one WAP client of the content of the at least one WAP transaction based on the at least one characteristic of the at least one WAP transaction destined for the at least one WAP client.

39. The device of claim 38, wherein the at least one characteristic of the at least one WAP transaction includes at least one of: Segmentation and Reassembly (SAR), Retransmission flag, WAP capabilities of the WAP client and the WAP gateway.

40. The device of claim 38, wherein the processor is additionally programmed to:
analyze the at least one WAP transaction by matching the at least one WAP transaction to the received GPRS monitoring information.

41. The device of claim 40, wherein the matching includes at least a partial correspondence of the at least one WAP transaction and the received GPRS monitoring information.

42. The device of claim 38, wherein the processor programmed to produce an optimized transmission includes adjusting the characteristics of the at least one WAP transaction according to the received GPRS monitoring information.

43. The device of claim 38, wherein the network interface is configured for continuously monitoring WAP traffic on the GPRS network.

44. The device of claim 43, wherein the processor is additionally programmed to: analyze the WAP traffic and produce the optimized transmission continuously, in response to the continuous monitoring by the network interface.

45. The device of claim 38, wherein the processor programmed to produce the optimized transmission includes the processor programmed for queuing and shaping packets of the at least one WAP transaction.

46. A system for processing packets comprising:
a Quality of Service (QoS) server;
a monitor for coupling to a network and detecting Wireless Application Protocol (WAP) traffic; and
an engine coupled to the QoS server and the monitor, the engine configured for: analyzing the WAP traffic for at least one characteristic of at least one WAP transaction destined for at least one WAP client; and, producing an optimized transmission for the at least one WAP client, based on the at least one characteristic of the at least one WAP transaction destined for the at least one WAP client, and the information about the at least one WAP client.

47. The system of claim 46, wherein the QoS server includes a traffic shaper and a packet classifier.

48. The system of claim 46, wherein the at least one characteristic of the at least one WAP transaction includes at least one of: Segmentation and Reassembly (SAR), Retransmission flag, WAP capabilities of the WAP client and the WAP gateway.

49. The system of claim 46, wherein the engine configured for analyzing the WAP traffic for at least one characteristic of at least one WAP transaction is additionally configured to:
analyze the at least one WAP transaction by matching the at least one WAP transaction to the detected WAP traffic.

50. The system of claim 49, wherein the matching includes at least a partial correspondence of the at least one WAP transaction and the detected WAP traffic.

51. The system of claim 46, wherein the engine configured for producing an optimized transmission is additionally configured for adjusting the characteristics of the at least one WAP transaction according to the detected WAP traffic.

52. The system of claim 38, wherein the monitor is configured for continuously monitoring WAP traffic on the network.

53. The system of claim 52, wherein the engine is additionally configured to: analyze the WAP traffic and produce the optimized transmission continuously, in response to the continuous monitoring of the WAP traffic on the network by the monitor.

54. The system of claim 46, wherein the engine configured to produce the optimized transmission is additionally configured queuing and shaping packets of the at least one WAP transaction.
